(19) United States
(12) Patent Application Publication
(10) Pub. No.: US 2026/0269124 A1
(43) Pub. Date: Sep. 10, 2026

(54) MULTILAYER CERAMIC CAPACITOR

(71) Applicant: Murata Manufacturing Co., Ltd., Nagaokakyo-shi (JP)

(72) Inventor: Yuu MIKAMI, Nagaokakyo-shi (JP)

(21) Appl. No.: 19/533,877

(22) Filed: Feb. 9, 2026

(30) Foreign Application Priority Data
Mar. 10, 2025 (JP) 2025-037184

(51) Int. Cl. H01G 4/012; H01G 4/248; H01G 4/30

(52) U.S. Cl. CPC H01G 4/012; H01G 4/248; H01G 4/30

(57) ABSTRACT

A multilayer ceramic capacitor includes a multilayer body including dielectric layers, internal electrodes, first through sixth surfaces, a first outer electrode on the third surface, and a second outer electrode on the fourth surface. The multilayer body includes internal electrodes including Cu and dielectric layers include a dielectric material with a perovskite structure including Ca and Zr. A ratio of a thickness of each of the internal electrodes in a laminating direction to a thickness in the laminating direction of each of the dielectric layers sandwiched between the internal electrodes in the laminating direction is equal to or less than about 0.48, and a ratio of a total volume of the internal electrodes to a volume of the multilayer body is equal to or less than about 0.085.

### CROSS REFERENCE TO RELATED APPLICATIONS

This application claims the benefit of priority to Japanese Patent Application No. 2025-037184 filed on Mar. 10, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

As a multilayer ceramic capacitor used in an electronic device, a multilayer ceramic capacitor having a high dielectric constant system and a multilayer ceramic capacitor for temperature compensation in which electrostatic capacitance changes linearly with respect to a temperature change as described in Japanese Unexamined Patent Application Publication No. 2018-24542 are known.

For example, a multilayer ceramic capacitor described in Japanese Unexamined Patent Application Publication No. 2009-7209 uses copper or an alloy including copper for an inner electrode and uses calcium zirconate as a main component for a dielectric layer.

### SUMMARY OF THE INVENTION

However, since copper, which has a relatively low melting point, is used for the internal electrode, when a volume of the internal electrode increases, excessive stress accumulates in the multilayer ceramic capacitor due to unbalanced shrinkage behavior between the dielectric and the internal electrode, which may undesirably cause a structural defect when an impact is applied. Furthermore, when the volume of the internal electrode is decreased to suppress the structural defect, a Q value and electrostatic capacitance may undesirably decrease.

Therefore, example embodiments of the present invention provide multilayer ceramic capacitors that each reduce or prevent an occurrence of a structural defect in a multilayer body by controlling a volume of internal electrodes with respect to a volume of the multilayer body.

A multilayer ceramic capacitor according to an example embodiment of the present invention is a multilayer ceramic capacitor including a multilayer body including a first surface and a second surface that are opposed to each other in a laminating direction, a third surface and a fourth surface that are opposed to each other in a first perpendicular or substantially perpendicular to the laminating direction, and a fifth surface and a sixth surface that are opposed to each other in a second perpendicular or substantially perpendicular to the laminating direction and the first direction, a first outer electrode on the third surface of the multilayer body, and a second outer electrode on the fourth surface of the multilayer body, in which the multilayer body includes internal electrodes and dielectric layers, the internal electrodes include Cu as a main component, the dielectric layers include a dielectric material with a perovskite structure including Ca and Zr as a main component, a ratio of a thickness of each of the internal electrodes in the laminating direction to a thickness in the laminating direction of each of the dielectric layers sandwiched between the internal electrodes in the laminating direction is equal to or less than about 0.48, and a ratio of a total volume of the internal electrodes to a volume of the multilayer body is equal to or less than about 0.085.

According to a multilayer ceramic capacitor according to an example embodiment of the present invention, the internal electrodes include Cu as a main component, the dielectric layers include a dielectric material with a perovskite structure including Ca and Zr as a main component, a ratio of a thickness of each of the internal electrodes in the laminating direction to a thickness in the laminating direction of each of the dielectric layers sandwiched between the internal electrodes in the laminating direction is equal to or less than about 0.48, and a ratio of a total volume of the internal electrodes to a volume of the multilayer body is equal to or less than about 0.085, and therefore an occurrence of a structural defect such as delamination in the multilayer body is reduced or prevented.

According to example embodiments of the present invention, it is possible to provide multilayer ceramic capacitors that each reduce or prevent an occurrence of a structural defect in a multilayer body by controlling a volume of internal electrodes with respect to a volume of the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to an example embodiment of the present invention.

FIG. 2 is a cross-sectional view taken along line II-II of FIG. 1.

FIG. 3 is a cross-sectional view taken along line III-III of FIG. 1.

FIG. 4 is a cross-sectional view taken along line IV-IV of FIG. 1.

FIG. 5 is an external perspective view illustrating an example of a multilayer ceramic capacitor according to Modification 1 of an example embodiment of the present invention.

FIG. 6 is a cross-sectional view taken along line VI-VI of FIG. 5.

FIG. 7 is a cross-sectional view taken along line VII-VII of FIG. 5.

FIG. 8 is a cross-sectional view taken along line VIII-VIII of FIG. 5.

FIG. 9 is an external perspective view illustrating an example of a multilayer ceramic capacitor according to Modification 2 of an example embodiment of the present invention.

FIG. 10 is a cross-sectional view taken along line X-X of FIG. 9.

FIG. 11 is a cross-sectional view taken along line XI-XI of FIG. 9.

FIG. 12 is a cross-sectional view taken along line XII-XII of FIG. 9.

FIG. 13 is a cross-sectional view illustrating Modification 3 of an example embodiment of the present invention in the cross-sectional view illustrated in FIG. 10.

### DETAILED DESCRIPTION OF THE EXAMPLE EMBODIMENTS

Multilayer ceramic capacitors according to example embodiments of the present invention are described.

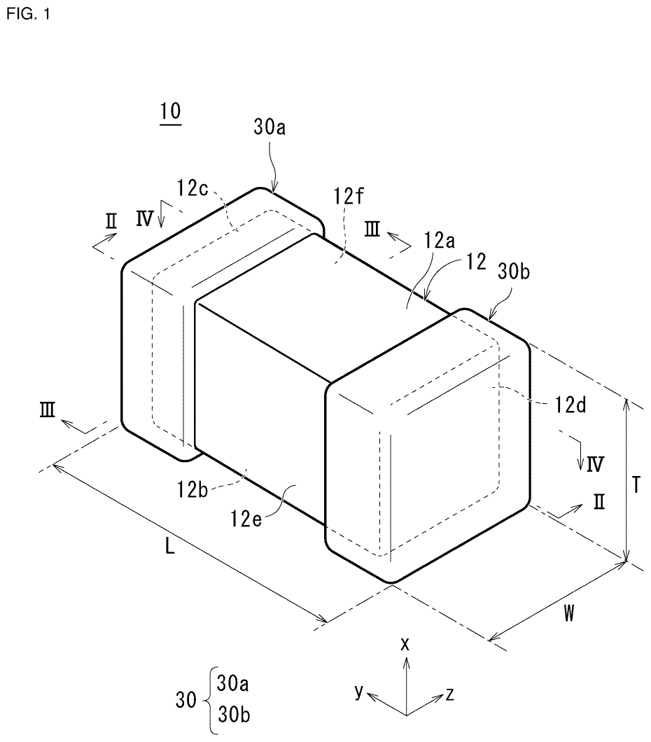

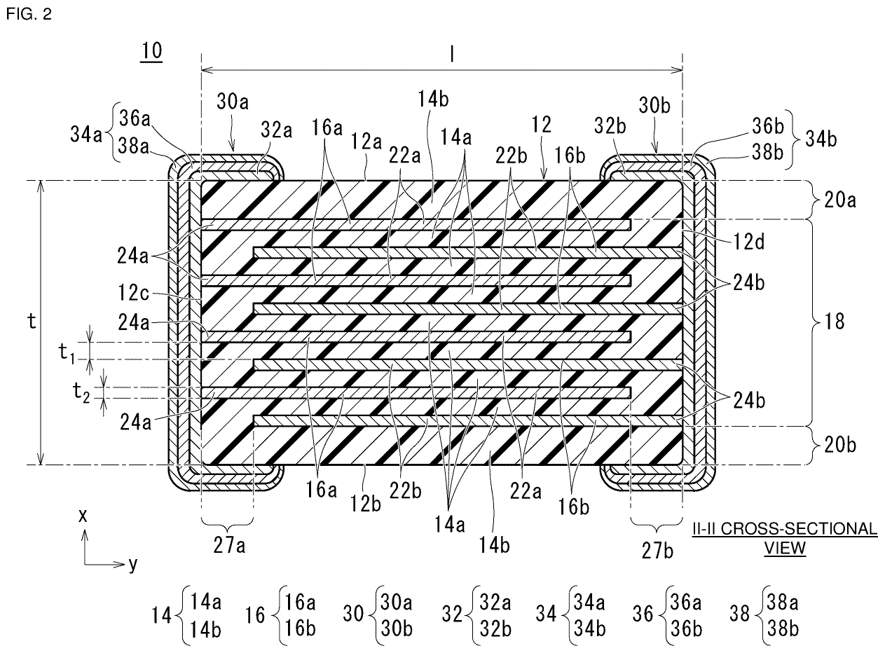

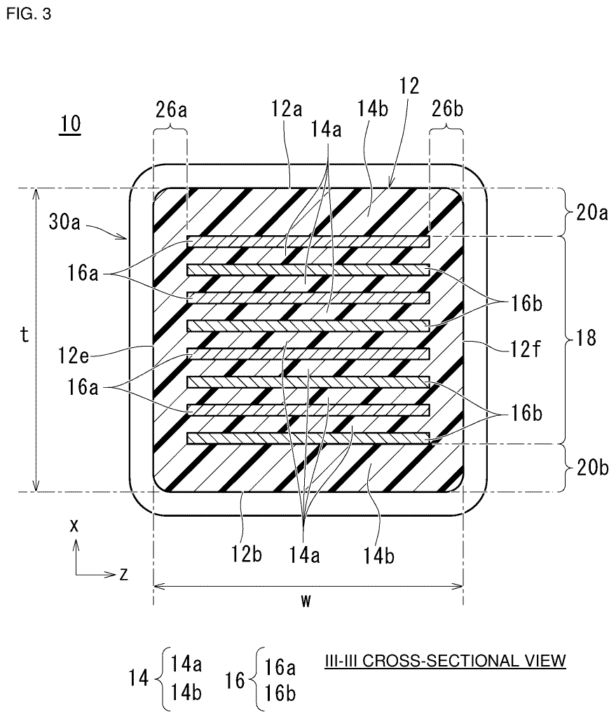

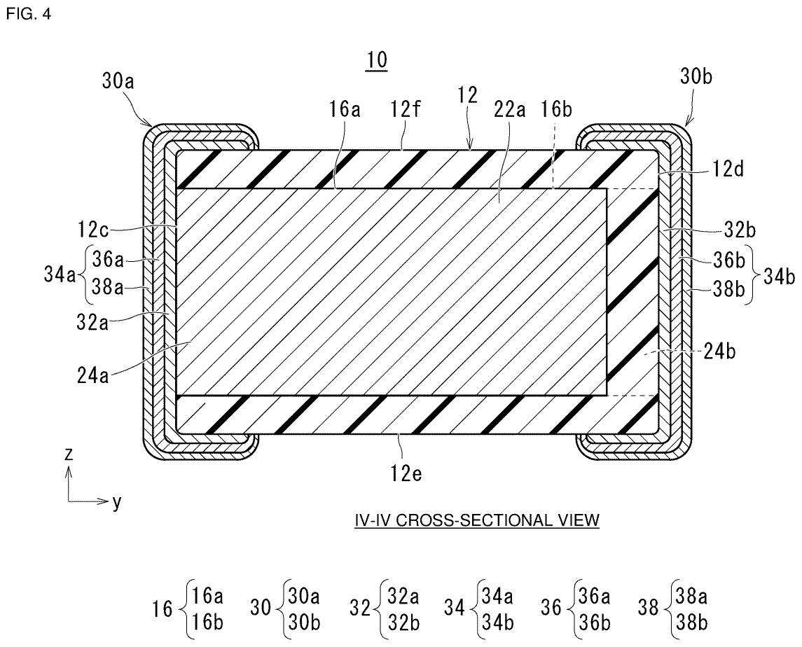

FIG. 1 is an external perspective view illustrating an example of the multilayer ceramic capacitor according to an example embodiment of the present invention. FIG. 2 is a cross-sectional view taken along line II-II of FIG. 1. FIG. 3 is a cross-sectional view taken along line III-III of FIG. 1. FIG. 4 is a cross-sectional view taken along line IV-IV of FIG. 1.

As illustrated in FIG. 1, the multilayer ceramic capacitor 10 includes a multilayer body 12 having a rectangular or substantially rectangular parallelepiped shape and an outer electrode 30 disposed at both end portions of the multilayer body 12.

The multilayer body 12 includes a plurality of dielectric layers 14 that are laminated and a plurality of internal electrodes 16 each of which is laminated on a corresponding one of the dielectric layers 14. Furthermore, the multilayer body 12 includes a first surface 12a and a second surface 12b that are opposed to each other in a laminating direction x, a third surface 12c and a fourth surface 12d that are opposed to each other in a first direction y orthogonal to the laminating direction x, and a fifth surface 12e and a sixth surface 12f that are opposed to each other in a second direction z orthogonal to the laminating direction x and the first direction y.

Note that the first surface 12a and/or the second surface 12b are preferably flat. In a case where the first surface 12a and/or the second surface 12b are flat, stress received from a nozzle that picks up the multilayer ceramic capacitor 10 can be distributed on the flat surface. As a result, a strength of the multilayer ceramic capacitor can be improved during mounting.

The surfaces of the multilayer body 12 may be roughened.

Corner portions and ridge portions of the multilayer body 12 may be rounded. A portion where two surfaces among the first surface 12a, the second surface 12b, the third surface 12c, the fourth surface 12d, the fifth surface 12e, and the sixth surface 12f intersect are referred to as a ridge portion, and a portion where three surfaces among the first surface 12a, the second surface 12b, the third surface 12c, the fourth surface 12d, the fifth surface 12e, and the sixth surface 12f intersect are referred to as a corner portion. The ridge portions and the corner portions are preferably rounded with a radius R. By rounding the ridge portions and the corner portions with a radius R, chipping can be prevented. In a case where the ridge portions and the corner portions are rounded with a radius R, the main surfaces may be flat except for the ridge portions and the corner portions.

Hereinafter, a dimension of the multilayer body 12 in the first direction y is referred to as a dimension 1, a dimension of the multilayer body 12 in the second direction z is referred to as a dimension w, and a dimension of the multilayer body 12 in the laminating direction x is referred to as a dimension t. The dimension t of the multilayer body 12 in the laminating direction x is preferably equal to or greater than about 0.115 mm and equal to or less than about 0.135 mm, the dimension 1 of the multilayer body 12 in the first direction y is preferably equal to or greater than about 0.240 mm and equal to or less than about 0.260 mm, and the dimension w of the multilayer body 12 in the second direction z is preferably equal to or greater than about 0.115 mm and equal to or less than about 0.135 mm, for example.

As illustrated in FIGS. 2 and 3, the multilayer body 12 includes an inner layer portion 18 in which the dielectric layers 14 and the internal electrodes 16 are alternately laminated in the laminating direction x connecting the first surface 12a and the second surface 12b, a first outer layer portion 20a including a plurality of dielectric layers 14 located between the internal electrode 16 closest to the first surface 12a and the first surface 12a, and a second outer layer portion 20b including a plurality of dielectric layers 14 located between the internal electrode 16 closest to the second surface 12b and the second surface 12b.

The inner layer portion 18 includes a plurality of inner dielectric layers 14a among the plurality of dielectric layers 14. That is, in the inner layer portion 18, the plurality of internal electrodes 16 face each other with the inner dielectric layer 14a interposed therebetween.

The inner dielectric layers 14a are dielectrics with a perovskite structure including at least Ca and Zr as main components. The inner dielectric layers 14a include, for example, CaZrO₃ as a dielectric component. The inner dielectric layers 14a may additionally include Ba, Ti, Sr, or the like. The inner dielectric layers 14a include Li, Na, or Si as a sintering additive. Each of the inner dielectric layers 14a is disposed between internal electrodes 16 that are adjacent in the laminating direction x.

The main components of the inner dielectric layers 14a can be observed as follows. Specifically, the multilayer ceramic capacitor 10 is ground in the second direction z so that a W dimension thereof in the second direction z is halved to expose a cross section in the laminating direction x and the first direction y. The exposed cross section is observed under a condition of a square of 30 μm by using TOF.SIM (manufactured by ION-TOF).

As illustrated in FIGS. 2 and 3, the internal electrodes 16 include a first internal electrode 16a and a second internal electrode 16b. The first internal electrode 16a and the second internal electrode 16b are alternately laminated with the inner dielectric layer 14a interposed therebetween.

The first internal electrode 16a is disposed on a corresponding one of the plurality of dielectric layers 14 and is located in the multilayer body 12. The first internal electrode 16a includes a first counter electrode portion 22a that faces the second internal electrode 16b and a first lead-out electrode portion 24a that is located at one end of the first internal electrode 16a and extends from the first counter electrode portion 22a to the third surface 12c of the multilayer body 12. An end portion of the first lead-out electrode portion 24a is drawn out to the third surface 12c and is exposed from the multilayer body 12. That is, the end portion of the first lead-out electrode portion 24a is not exposed on the first surface 12a, the second surface 12b, the fourth surface 12d, the fifth surface 12e, and the sixth surface 12f.

A shape of the first counter electrode portion 22a of the first internal electrode 16a is not limited in particular, and is preferably a rectangular or substantially rectangular shape in plan view. Note that corner portions of the first counter electrode portion 22a in plan view may be rounded or the corner portions may be inclined (tapered) in plan view. Alternatively, the corner portions may have a tapered shape inclined toward one side in plan view.

A shape of the first lead-out electrode portion 24a of the first internal electrode 16a is not limited in particular, and is preferably a rectangular or substantially rectangular shape in plan view. Note that corner portions of the first lead-out electrode portion 24a in plan view may be rounded or the corner portions may be inclined (tapered) in plan view. Alternatively, the corner portions may have a tapered shape inclined toward one side in plan view.

A width of the first counter electrode portion 22a of the first internal electrode 16a and a width of the first lead-out electrode portion 24a of the first internal electrode 16a may be identical or one of these widths may be smaller than the other.

The second internal electrode 16b is disposed on a corresponding one of the plurality of dielectric layers 14 and is located in the multilayer body 12. The second internal electrode 16b includes a second counter electrode portion 22b that faces the first internal electrode 16a and a second lead-out electrode portion 24b that is located at one end of the second internal electrode 16b and extends from the second counter electrode portion 22b to the fourth surface 12d of the multilayer body 12. An end portion of the second lead-out electrode portion 24b is drawn out to the fourth surface 12d and is exposed from the multilayer body 12. That is, the end portion of the second lead-out electrode portion 24b is not exposed on the first surface 12a, the second surface 12b, the third surface 12c, the fifth surface 12e, and the sixth surface 12f.

A shape of the second counter electrode portion 22b of the second internal electrode 16b is not limited in particular, and is preferably a rectangular or substantially rectangular shape in plan view. Note that corner portions of the second counter electrode portion 22b in plan view may be rounded or the corner portions may be inclined (tapered) in plan view. Alternatively, the corner portions may have a tapered shape inclined toward one side in plan view.

A shape of the second lead-out electrode portion 24b of the second internal electrode 16b is not limited in particular, and is preferably a rectangular or substantially rectangular shape in plan view. Note that corner portions of the second lead-out electrode portion 24b in plan view may be rounded or the corner portions may be inclined (tapered) in plan view. Alternatively, the corner portions may have a tapered shape inclined toward one side in plan view.

A width of the second counter electrode portion 22b of the second internal electrode 16b and a width of the second lead-out electrode portion 24b of the second internal electrode 16b may be identical or one of these widths may be smaller than the other.

As illustrated in FIG. 3, the multilayer body 12 includes a side portion 26a of the multilayer body 12 provided between one end of each of the first counter electrode portion 22a and the second counter electrode portion 22b in the second direction z and the fifth surface 12e and a side portion 26b of the multilayer body 12 provided between the other end of each of the first counter electrode portion 22a and the second counter electrode portion 22b in the second direction z and the sixth surface 12f.

As illustrated in FIG. 2, the multilayer body 12 includes an end portion 27a of the multilayer body 12 provided between an end portion of the first internal electrode 16a that is located opposite to the first lead-out electrode portion 24a and the fourth surface 12d and an end portion 27b of the multilayer body 12 provided between an end portion of the second internal electrode 16b that is located opposite to the second lead-out electrode portion 24b and the third surface 12c.

The internal electrodes 16 include, for example, Cu as a main component. This can lower electric resistance of the internal electrodes 16, thereby reducing ESR. In addition, in a case where the internal electrodes 16 include Cu as a main component, the internal electrodes 16 can be formed by using an inexpensive material.

The main component of the internal electrodes 16 can be observed as follows. Specifically, the multilayer ceramic capacitor 10 is ground in the second direction z so that the W dimension thereof in the second direction z is halved to expose a cross section in the laminating direction x and the first direction y. Then, the exposed cross section is observed under a condition of a square of 30 μm by using TOF.SIM (manufactured by ION-TOF).

A thickness t₂ of each of the internal electrodes 16 in the laminating direction x is preferably equal to or greater than about 0.5 μm and equal to or less than about 3.5 μm, for example. The total number of first internal electrode 16a and second internal electrode 16b is preferably 6 or more, for example.

A ratio of the thickness t₂ of each of the internal electrodes 16 in the laminating direction x to a thickness t₁ of each of the dielectric layers 14 in the laminating direction x is equal to or less than about 0.48, for example. A ratio of a total volume of the internal electrodes 16 to a volume of the multilayer body 12 is equal to or less than about 0.085, for example. This reduces or prevents an occurrence of a structural defect such as delamination in the multilayer body 12.

The ratio of the total volume of the internal electrodes 16 to the volume of the multilayer body 12 is preferably equal to or greater than about 0.060, is more preferably equal to or greater than about 0.066, for example. This reduces or prevents an occurrence of a structural defect such as delamination in the multilayer body 12 while keeping high electrostatic capacitance.

The volume of the multilayer body 12 is calculated by (a maximum value of the dimension 1 of the multilayer body 12)×(a maximum value of the dimension t of the multilayer body 12)×(a maximum value of the dimension w of the multilayer body 12). Note that the volume of the multilayer body 12 is calculated in a similar manner also in a case where the corner portions and the ridge portions of the multilayer body 12 are rounded with a radius R.

The total volume of the internal electrodes 16 is calculated as follows. First, the outer electrode 30 disposed on the multilayer body 12 is peeled off, and an area A is measured by (the dimension w of the internal electrodes 16 disposed in the multilayer body 12)×(the thickness t₂ of the internal electrodes 16 in the laminating direction x). The area A is an average of the cross sections of the internal electrodes 16 exposed on the third surface 12c and the fourth surface 12d. Then, the multilayer body 12 is ground in the second direction z so that the dimension thereof is halved to expose a cross section of the multilayer body 12 in the first direction y and the laminating direction x. On the exposed cross section of the multilayer body 12, the number of laminated internal electrodes 16 and the dimension of the internal electrodes 16 in the first direction y are calculated. Then, the total volume of the internal electrodes 16 is calculated by (the area A)×(the number of laminated internal electrodes 16)×(the thickness t₂ of the internal electrodes 16 in the laminating direction x).

Note that in a case where the dimensions of the internal electrodes 16 in the second direction z are not uniform but vary in shape, the multilayer body 12 is ground in the laminating direction x to expose the internal electrode 16 closest to the first surface 12a, and then an area B is measured by (the dimension of the internal electrode 16 in the first direction y)×(the dimension of the internal electrode 16 in the second direction z). Then, the number of laminated internal electrodes 16 and the thickness t₂ of the internal electrodes 16 in the laminating direction x are calculated after grinding in the first direction y. Then, the total volume of the internal electrodes 16 is calculated by (the area B)×(the number of laminated internal electrodes 16)×(the dimension of the internal electrodes 16 in the first direction y).

The thickness t₁ of the dielectric layers 14 in the laminating direction x and the thickness t₂ of the internal electrodes 16 in the laminating direction x are calculated as averages of values measured at five points at equal intervals in each of three layers in a portion where no structural defect is occurring.

The first outer layer portion 20a is an aggregate of a plurality of outer dielectric layers 14b, which are a plurality of dielectric layers 14 located close to the first surface 12a of the multilayer body 12 and located between the first surface 12a and the internal electrode 16 closest to the first surface 12a. The second outer layer portion 20b is an aggregate of a plurality of outer dielectric layers 14b, which are a plurality of dielectric layer 14 located close to the second surface 12b of the multilayer body 12 and located between the second surface 12b and the internal electrode 16 closest to the second surface 12b. A region sandwiched between the first outer layer portion 20a and the second outer layer portion 20b is the inner layer portion 18.

The first outer layer portion 20a and the second outer layer portion 20b each include an insulating material. The first outer layer portion 20a and the second outer layer portion 20b may include a dielectric material of the same type as the inner dielectric layers 14a. The inner dielectric layers 14a may be different in amount of additive from the first outer layer portion 20a and the second outer layer portion 20b. In the present example embodiment, the inner dielectric layers 14a and the outer dielectric layers 14b use the same material as a main component.

A dimensional ratio of the thickness of the first outer layer portion 20a to the thickness of the second outer layer portion 20b is preferably equal to or greater than 1:1 and equal to or less than 1:3, for example.

In a case where the dimensions of the multilayer ceramic capacitor 10 are set so that a L dimension thereof in the first direction y is equal to or less than about 0.8 mm, a W dimension thereof in the second direction z is equal to or less than about 1.6 mm, and a T dimension thereof in the laminating direction x is equal to or less than about 0.8 mm, the thicknesses of the first outer layer portion 20a and the second outer layer portion 20b are preferably equal to or greater than about 5 μm and equal to or less than about 15 μm, for example. In a case where the thicknesses of the outer layer portions are outside the above range on one side, arrangement of the internal electrodes becomes unbalanced, and a structural defect such as delamination in the multilayer body 12 is more likely to occur due to a difference in coefficient of linear expansion.

As illustrated in FIG. 1, the outer electrode 30 is disposed on the third surface 12c and the fourth surface 12d of the multilayer body 12.

The outer electrode 30 includes a base electrode layer 32 including a metal component and glass and a plating layer 34 disposed on a surface of the base electrode layer 32.

The outer electrode 30 includes a first outer electrode 30a and a second outer electrode 30b.

The first outer electrode 30a is connected to the first internal electrode 16a and is disposed on at least the third surface 12c. The first outer electrode 30a extends from the third surface 12c of the multilayer body 12 onto a portion of the first surface 12a, a portion of the second surface 12b, a portion of the fifth surface 12e, and a portion of the sixth surface 12f. In this case, the first outer electrode 30a is electrically connected to the first lead-out electrode portion 24a of the first internal electrode 16a.

The second outer electrode 30b is connected to the second internal electrode 16b and is disposed at least on the fourth surface 12d. The second outer electrode 30b extends from the fourth surface 12d of the multilayer body 12 onto a portion of the first surface 12a, a portion of the second surface 12b, a portion of the fifth surface 12e, and a portion of the sixth surface 12f. In this case, the second outer electrode 30b is electrically connected to the second lead-out electrode portion 24b of the second internal electrode 16b.

In the multilayer body 12, the first counter electrode portion 22a of the first internal electrode 16a and the second counter electrode portion 22b of the second internal electrode 16b face each other with the dielectric layer 14 interposed therebetween, and thus electrostatic capacitance is generated. This provides electrostatic capacitance between the first outer electrode 30a to which the first internal electrode 16a is connected and the second outer electrode 30b to which the second internal electrode 16b is connected, thus exhibiting characteristics of the capacitor.

The base electrode layer 32 includes a first base electrode layer 32a and a second base electrode layer 32b.

The first base electrode layer 32a is connected to the first internal electrode 16a and is disposed on the third surface 12c. The first base electrode layer 32a extends from the third surface 12c onto a portion of the first surface 12a, a portion of the second surface 12b, a portion of the fifth surface 12e, and a portion of the sixth surface 12f. In this case, the first base electrode layer 32a is electrically connected to the first lead-out electrode portion 24a of the first internal electrode 16a.

The second base electrode layer 32b is connected to the second internal electrode 16b and is disposed on the fourth surface 12d. The second base electrode layer 32b extends from the fourth surface 12d onto a portion of the first surface 12a, a portion of the second surface 12b, a portion of the fifth surface 12e, and a portion of the sixth surface 12f. In this case, the second base electrode layer 32b is electrically connected to the second lead-out electrode portion 24b of the second internal electrode 16b.

The base electrode layer 32 includes Cu as a main component. The base electrode layer 32 may include a glass component in addition to Cu as a main component. Since the base electrode layer 32 includes Cu, which has low specific resistance, as a main component, the ESR of the multilayer ceramic capacitor 10 can be lowered. In a case where the base electrode layer 32 includes a glass component, sinterability of the base electrode layer 32 can be improved. Examples of the glass component include Na, B, Si, Zn, and Ba. Alternatively, the base electrode layer 32 may include Cu as a main component and include an auxiliary material.

A thickness of the first base electrode layer 32a in the first direction y connecting the third surface 12c and the fourth surface 12d at a central portion thereof in the laminating direction x located on the third surface 12c is, for example, preferably equal to or greater than approximately 10 μm and equal to or less than approximately 40 μm.

A thickness of the second base electrode layer 32b in the first direction y connecting the third surface 12c and the fourth surface 12d at a central portion thereof in the laminating direction x located on the fourth surface 12d is, for example, preferably equal to or greater than approximately 10 μm and equal to or less than approximately 40 μm.

Next, a first plating layer 34a and a second plating layer 34b, which are the plating layer 34 disposed on the base electrode layer 32, are described with reference to FIG. 2.

The first plating layer 34a and the second plating layer 34b include, for example, at least one selected from among Cu, Ni, Sn, Ag, Pd, an Ag—Pd alloy, Au, and the like.

The first plating layer 34a is disposed so as to cover the first base electrode layer 32a. The second plating layer 34b is disposed so as to cover the second base electrode layer 32b.

The first plating layer 34a and the second plating layer 34b may include a plurality of layers. In this case, each plating layer 34 preferably has a two-layer structure including a lower plating layer (Ni plating layer) including Ni plating on the base electrode layer 32 and an upper plating layer (Sn plating layer) formed by Sn plating on the lower plating layer. That is, in this case, the first plating layer 34a includes a first lower plating layer 36a and a first upper plating layer 38a located on a surface of the first lower plating layer 36a. The second plating layer 34b includes a second lower plating layer 36b and a second upper plating layer 38b located on a surface of the second lower plating layer 36b.

The lower plating layer 36 formed by Ni plating is used to prevent the base electrode layer 32 from being eroded by solder during mounting of the multilayer ceramic capacitor 10, and the upper plating layer 38 formed by Sn plating is used to improve wettability of solder during mounting of the multilayer ceramic capacitor 10 and facilitate the mounting. A thickness of each of the lower plating layer 36 and the upper plating layer 38 is preferably equal to or greater than about 1.0 μm and equal to or less than about 15.0 μm, for example.

A dimension in the first direction y of the multilayer ceramic capacitor 10 including the multilayer body 12, the first outer electrode 30a, and the second outer electrode 30b is referred to as the L dimension, a dimension in the laminating direction x of the multilayer ceramic capacitor 10 including the multilayer body 12, the first outer electrode 30a, and the second outer electrode 30b is referred to as the T dimension, and a dimension in the second direction z of the multilayer ceramic capacitor 10 including the multilayer body 12, the first outer electrode 30a, and the second outer electrode 30b is referred to as the W dimension. The dimensions of the multilayer ceramic capacitor 10 are set so that the L dimension in the first direction y is equal to or greater than about 0.25 mm and equal to or less than about 2.0 mm, the W dimension in the second direction z is equal to or greater than about 0.125 mm and equal to or less than about 1.25 mm, and the T dimension in the laminating direction x is equal to or greater than about 0.125 mm and equal to or less than about 1.25 mm, for example. The dimensions of the multilayer ceramic capacitor 10 can be measured by a microscope.

In the multilayer ceramic capacitor 10 illustrated in FIG. 1, the ratio of the thickness of each of the internal electrodes 16 in the laminating direction x to the thickness of each of the dielectric layers 14 is equal to or less than about 0.48, and the ratio of the total volume of the internal electrodes 16 to the volume of the multilayer body 12 is equal to or less than about 0.085, for example, and therefore an occurrence of a structural defect such as delamination in the multilayer body 12 is reduced or prevented.

Furthermore, in the multilayer ceramic capacitor 10 illustrated in FIG. 1, in a case where the ratio of the total volume of the internal electrodes 16 to the volume of the multilayer body 12 is equal to or greater than about 0.060, an occurrence of a structural defect such as delamination in the multilayer body 12 is reduced or prevented while keeping high electrostatic capacitance. Furthermore, in the multilayer ceramic capacitor 10 illustrated in FIG. 1, in a case where the ratio of the total volume of the internal electrodes 16 to the volume of the multilayer body 12 is equal to or greater than about 0.066, an occurrence of a structural defect such as delamination in the multilayer body 12 is reduced or prevented while keeping high electrostatic capacitance.

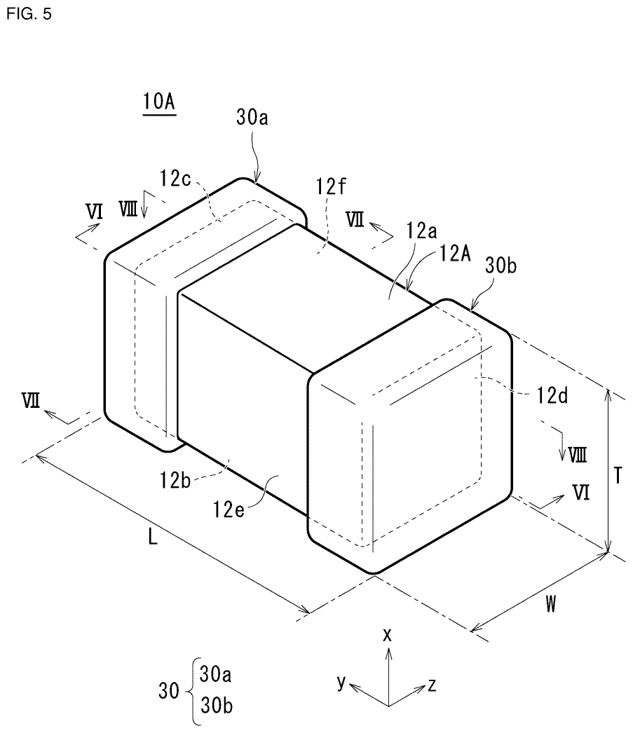

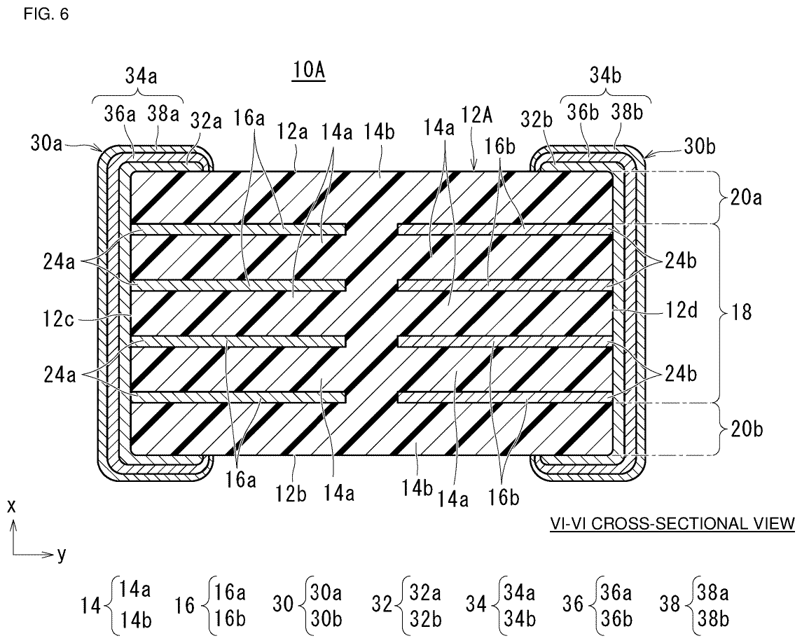

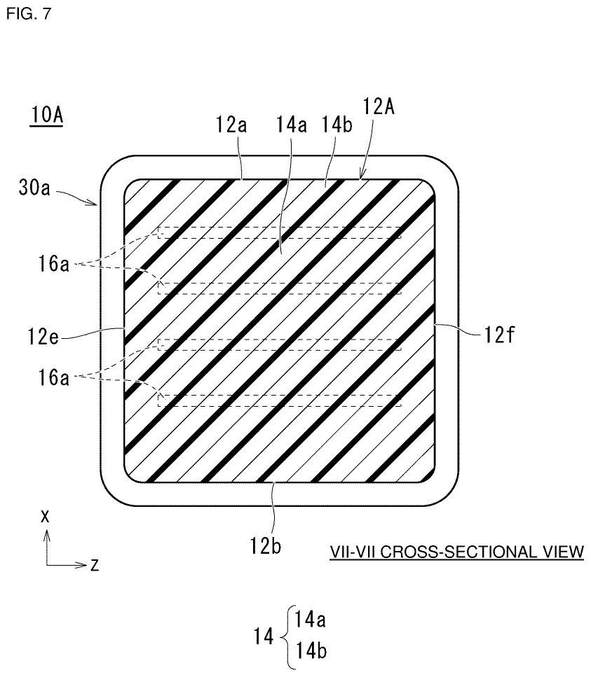

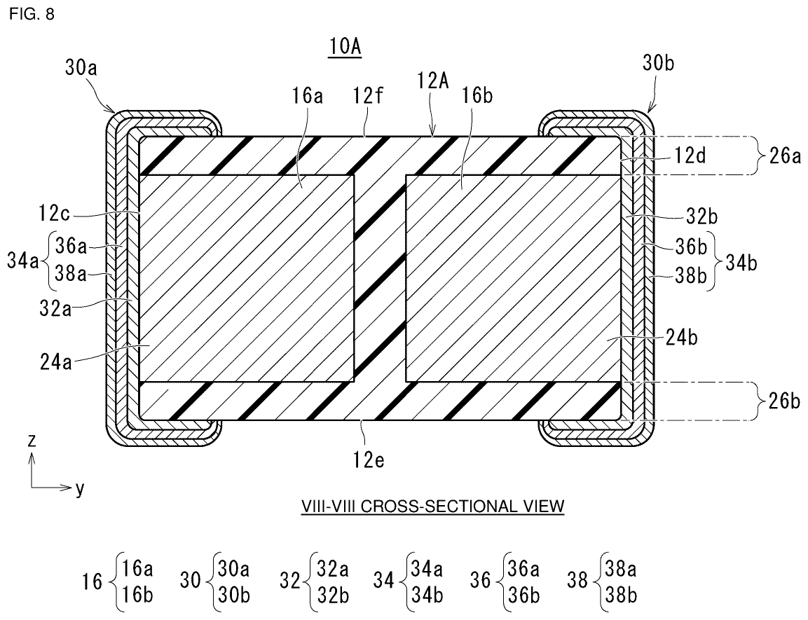

Next, an example of a multilayer ceramic capacitor 10A according to Modification 1 of the present example embodiment is described. FIG. 5 is an external perspective view illustrating an example of the multilayer ceramic capacitor according to Modification 1 of an example embodiment of the present invention. FIG. 6 is a cross-sectional view taken along line VI-VI of FIG. 5. FIG. 7 is a cross-sectional view taken along line VII-VII of FIG. 5. FIG. 8 is a cross-sectional view taken along line VIII-VIII of FIG. 5. Elements or features identical or corresponding to those in FIGS. 1 to 4 are given identical reference signs, and detailed description thereof is omitted.

The multilayer ceramic capacitor 10A according to Modification 1 of the present example embodiment includes a multilayer body 12A having a rectangular or substantially rectangular parallelepiped shape and the outer electrode 30 disposed at both end portions of the multilayer body 12A.

The multilayer body 12A includes the plurality of dielectric layers 14 that are laminated. Furthermore, the multilayer body 12A includes the first surface 12a and the second surface 12b that are opposed to each other in the laminating direction x, the third surface 12c and the fourth surface 12d that are opposed to each other in the first direction y orthogonal to the laminating direction x, and the fifth surface 12e and the sixth surface 12f that are opposed to each other in the second direction z orthogonal to the laminating direction x and the first direction y.

As illustrated in FIG. 6, in the multilayer body 12A, the first internal electrode 16a and the second internal electrode 16b are arranged on the same inner dielectric layer 14a apart from each other by a predetermined interval in the inner layer portion 18. That is, the first internal electrode 16a and the second internal electrode 16b are opposed to each other in the first direction y.

According to the multilayer ceramic capacitor 10A according to Modification 1 illustrated in FIG. 5, effects similar to those of the multilayer ceramic capacitor 10 of FIG. 1 are produced.

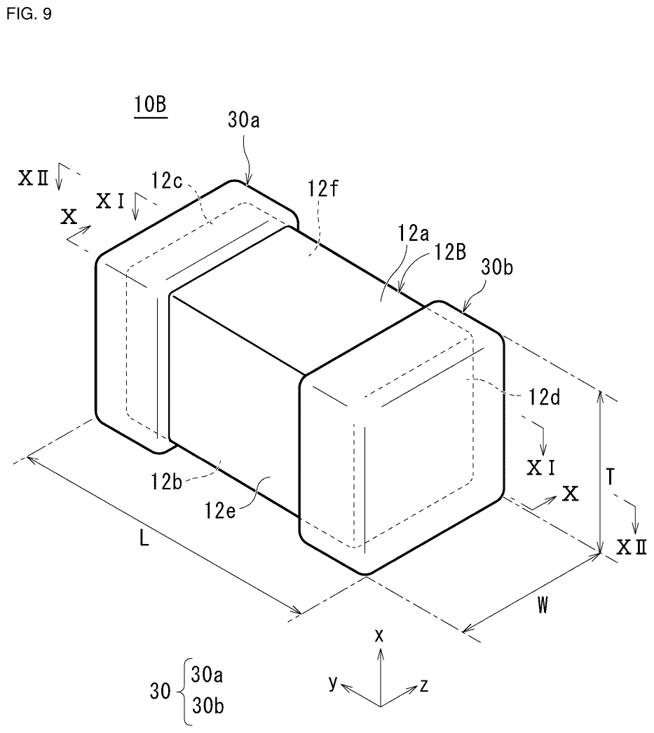

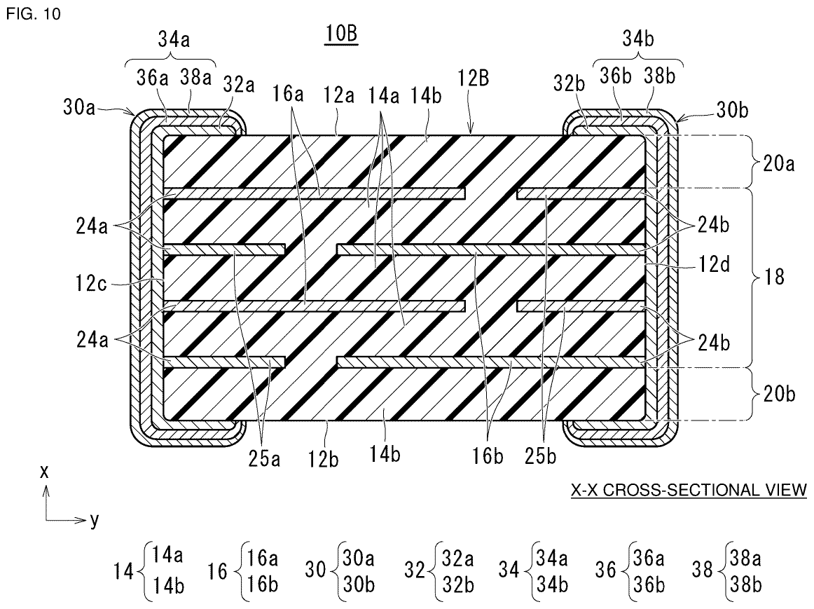

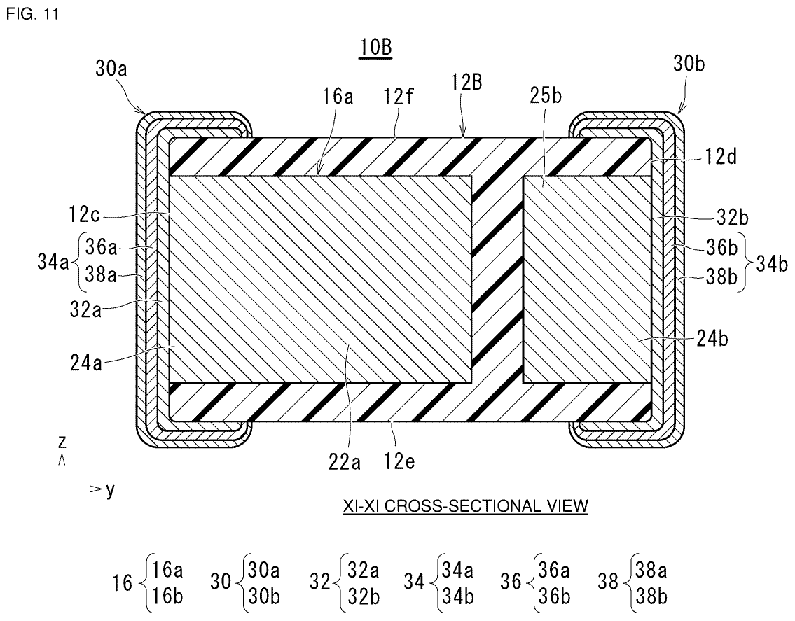

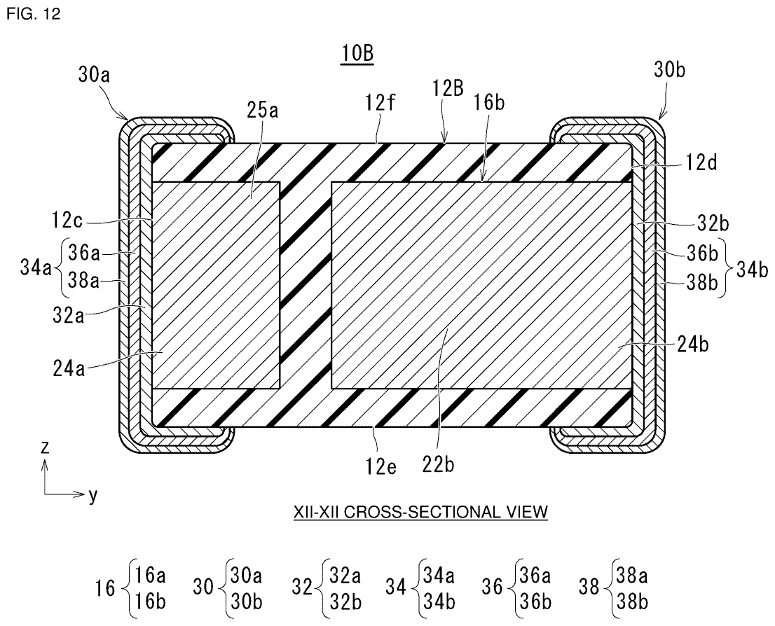

Next, an example of a multilayer ceramic capacitor 10B according to Modification 2 of the present example embodiment is described. FIG. 9 is an external perspective view illustrating an example of the multilayer ceramic capacitor according to Modification 2 of the present example embodiment of the present invention. FIG. 10 is a cross-sectional view taken along line X-X of FIG. 9. FIG. 11 is a cross-sectional view taken along line XI-XI of FIG. 9. FIG. 12 is a cross-sectional view taken along line XII-XII of FIG. 9. Elements or features identical or corresponding to those in FIGS. 1 to 4 are given identical reference signs, and detailed description thereof is omitted.

The multilayer ceramic capacitor 10B according to Modification 2 of the present example embodiment includes a multilayer body 12B having a rectangular or substantially rectangular parallelepiped shape and the outer electrode 30 disposed at both end portions of the multilayer body 12B.

The multilayer body 12B includes the plurality of dielectric layers 14 that are laminated. Furthermore, the multilayer body 12B includes the first surface 12a and the second surface 12b that are opposed to each other in the laminating direction x, the third surface 12c and the fourth surface 12d that are opposed to each other in the first direction y orthogonal to the laminating direction x, and the fifth surface 12e and the sixth surface 12f that are opposed to each other in the second direction z orthogonal to the laminating direction x and the first direction y.

As illustrated in FIGS. 10 to 12, the multilayer body 12B includes the first internal electrode 16a and the second internal electrode 16b as the internal electrodes 16.

The first internal electrode 16a is electrically connected to the first outer electrode 30a. The second internal electrode 16b is electrically connected to the second outer electrode 30b.

A first dummy electrode 25a is disposed in an end portion (L gap) 27b of the multilayer body 12B so as to be exposed on the third surface 12c. A second dummy electrode 25b is disposed in an end portion (L gap) 27a of the multilayer body 12B so as to be exposed on the fourth surface 12d.

Preferably, the first dummy electrode 25a is disposed on a same plane as the second internal electrode 16b and has a thickness equivalent to that of the second internal electrode 16b. Preferably, the second dummy electrode 25b is disposed on a same plane as the first internal electrode 16a and has a thickness equivalent to that of the first internal electrode 16a.

The first dummy electrode 25a and the second dummy electrode 25b may be disposed in the first outer layer portion 20a and the second outer layer portion 20b. In this case, the first dummy electrode 25a and the second dummy electrode 25b are preferably disposed on portions corresponding to positions obtained by parallelly shifting the end portions (L gaps) 27a and 27b of the multilayer body 12 in the laminating direction x. By thus providing the first dummy electrode 25a and the second dummy electrode 25b, it is easier to form a plating layer in a case where the plating layer is provided without providing the base electrode layer 32.

Note that in a case where the first dummy electrode 25a is provided on a same plane as the second internal electrode 16b, the first dummy electrode 25a and the second internal electrode 16b can be disposed on the same plane by printing the first dummy electrode 25a together with the second internal electrode 16b when printing the second internal electrode 16b. In a case where the second dummy electrode 25b is provided on a same plane as the first internal electrode 16a, the second dummy electrode 25b can be printed together with the first internal electrode 16a when printing the first internal electrode 16a.

According to the multilayer ceramic capacitor 10B according to Modification 2 illustrated in FIG. 9, effects similar to those of the multilayer ceramic capacitor 10 of FIG. 1 are produced.

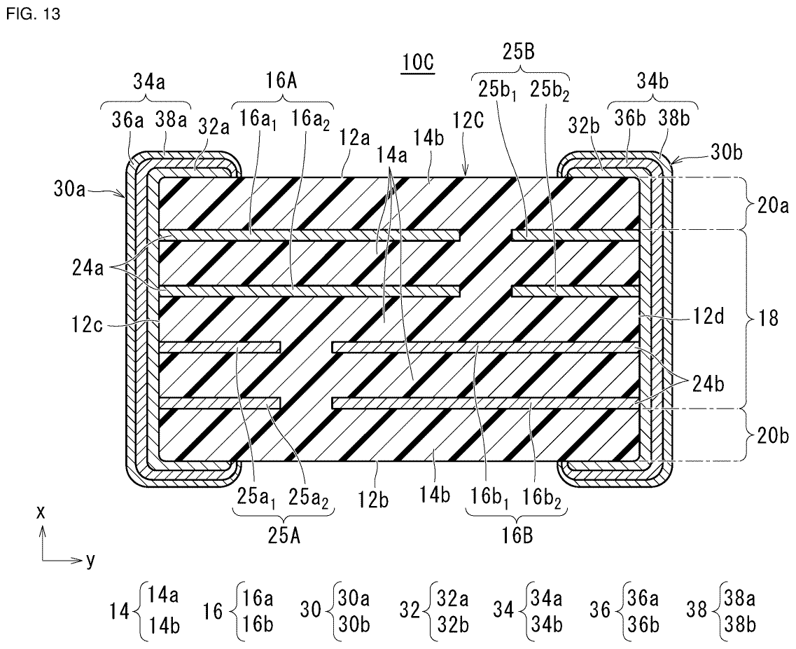

Next, an example of a multilayer ceramic capacitor 10C according to Modification 3 of the present example embodiment is described. FIG. 13 is a cross-sectional view illustrating Modification 3 of an example embodiment of the present invention in the cross-sectional view illustrated in FIG. 10. Elements or features identical or corresponding to those in FIGS. 1 to 4 are given identical reference signs, and detailed description thereof is omitted.

As illustrated in FIG. 13, a multilayer body 12C of the multilayer ceramic capacitor 10C according to Modification 3 of the present example embodiment includes a pair of first internal electrodes 16A and a pair of second internal electrodes 16B as the internal electrodes 16. This is not restrictive, and three or more first internal electrodes 16A may be consecutively laminated, and three or more second internal electrodes 16B may be consecutively laminated.

The pair of first internal electrodes 16A include two first internal electrodes 16a₁ and 16a₂ consecutively adjacent in the laminating direction x. The pair of first internal electrodes 16A are electrically connected to the first outer electrode 30a. The pair of second internal electrodes 16B include two second internal electrodes 16b₁ and 16b₂ consecutively adjacent in the laminating direction x. The pair of second internal electrodes 16B are electrically connected to the second outer electrode 30b.

A pair of first dummy electrodes 25A are disposed in the end portion (L gap) 27b of the multilayer body 12C so as to be exposed on the third surface 12c. A pair of second dummy electrodes 25B are disposed in the end portion (L gap) 27a of the multilayer body 12C so as to be exposed on the fourth surface 12d.

The pair of first dummy electrodes 25A include two first dummy electrodes 25a₁ and 25a₂ consecutively adjacent in the laminating direction x. Preferably, the first dummy electrodes 25a₁ and 25a₂ that define the pair of first dummy electrodes 25A are disposed on same planes as the second internal electrodes 16b₁ and 16b₂ that define the pair of second internal electrodes 16B and have thicknesses equivalent to those of the second internal electrodes 16b₁ and 16b₂. The pair of second dummy electrodes 25B include two second dummy electrodes 25b₁ and 25b₂ consecutively adjacent in the laminating direction x. Preferably, the second dummy electrodes 25b₁ and 25b₂ that define the pair of second dummy electrodes 25B are disposed on same planes as the first internal electrodes 16a₁ and 16a₂ that define the pair of first internal electrodes 16A and have thicknesses equivalent to those of the first internal electrodes 16a₁ and 16a₂.

According to the multilayer ceramic capacitor 10C according to Modification 3 illustrated in FIG. 13, effects similar to those of the multilayer ceramic capacitor 10 of FIG. 1 are produced.

Next, an example of a method for manufacturing the multilayer ceramic capacitor according to the present example embodiment is described.

First, a ceramic green sheet for a dielectric layer and conductive paste for an internal electrode are prepared. The ceramic green sheet and the conductive paste for an internal electrode include a binder and an organic solvent. The binder and the organic solvent may be known ones.

The ceramic green sheet for an inner dielectric layer is, for example, including dielectric paste including CaZrO₃. More specifically, the dielectric paste includes at least Ca and Zr as main components. The dielectric paste may additionally include Ba, Ti, Sr, or the like. The dielectric paste includes Li, Na, or Si as a sintering additive.

Then, the conductive paste for an internal electrode is printed on the ceramic green sheet for an inner dielectric layer in a predetermined pattern by a method such as screen printing and gravure printing. In this way, a ceramic green sheet on which a pattern of the first internal electrode has been formed and a ceramic green sheet on which a pattern of the second internal electrode has been formed are prepared.

Next, a predetermined number of ceramic green sheets for an outer layer on which a pattern of an internal electrode is not printed are laminated to form a portion that will serve as the second outer layer portion on the second surface side. Then, the ceramic green sheet on which the pattern of the first internal electrode has been formed and the ceramic green sheet on which the pattern of the second internal electrode has been formed are sequentially laminated on the portion that will serve the second outer layer portion so as to constitute the structure of the present invention, and thus a portion that will serve as the inner layer portion is formed. A predetermined number of ceramic green sheets for an outer layer on which the pattern of the internal electrode is not printed are laminated on the portion that will serve as the inner layer portion, and thus a portion that will serve as the first outer layer portion on the first surface side is formed. In this way, a multilayer sheet is produced.

Next, a multilayer block is produced by pressing the multilayer sheet in the laminating direction by isostatic pressing, for example.

Then, a multilayer chip is cut out by cutting the multilayer block into a predetermined size. Corner portions and ridge portions of the multilayer chip may be rounded by barrel polishing or the like.

Next, the multilayer body 12 is produced by firing the multilayer chip. A firing temperature is preferably equal to or greater than about 900° C. and equal to or less than about 1400° C., for example, although the firing temperature depends on materials of the dielectric layer that is a dielectric and the internal electrode layer.

Next, conductive paste for a base electrode layer including a metal component and a glass component is prepared.

Next, the first outer electrode 30a and the second outer electrode 30b are formed on the third surface 12c and the fourth surface 12d of the multilayer body 12, respectively. That is, first, the paste for the base electrode layer is applied to the third surface 12c and the fourth surface 12d of the multilayer body 12 and is then baked to form the first base electrode layer 32a of the first outer electrode 30a and the second base electrode layer 32b of the second outer electrode 30b. The application of the paste for the base electrode to both end surfaces of the multilayer body is, for example, performed by a method such as dipping or screen printing. A baking temperature is preferably equal to or greater than about 700° C. and equal to or less than about 900° C., for example. The paste for the base electrode layer preferably includes metal powder that is Cu and glass powder as main components.

Next, a plating layer is formed by plating a surface of the base electrode layer as necessary. In the present example embodiment, two plating layers are formed on the surface of the base electrode layer. Specifically, a Ni plating layer and a Sn plating layer are formed on the base electrode layer. Electrolytic plating is preferably used as the plating. The Ni plating layer and the Sn plating layer are sequentially formed, for example, by a barrel plating method.

In this way, the multilayer ceramic capacitor 10 according to the present example embodiment is manufactured.

Next, to confirm the effects of the multilayer ceramic capacitors according to example embodiments of the present invention, multilayer ceramic capacitors that vary in ratio of a thickness of an internal electrode in the laminating direction x to a thickness in the laminating direction x of a dielectric layer sandwiched between internal electrodes in the laminating direction and multilayer ceramic capacitors that vary in ratio of a total volume of internal electrodes to a volume of a multilayer body were produced as samples for an experiment according to the above manufacturing method, and an impact test was conducted.

Multilayer ceramic capacitors that are samples of Examples 1 to 10 and Comparative Examples 1 to 3 were produced by using the manufacturing method according to the above example embodiment.
Structure of multilayer ceramic capacitor: the multilayer ceramic capacitor illustrated in FIG. 1
Dimension of multilayer ceramic capacitor in first direction: 0.250 mm
Dimension of multilayer ceramic capacitor in second direction: 0.125 mm
Dimension of multilayer ceramic capacitor in laminating direction: 0.125 mm
Main component of internal electrodes: Cu
Main component of inner dielectric layers: CaZrO₃
Main component of base electrode layer: including Cu and a glass component
Plating layer: two layers, specifically, a Ni plating layer and a Sn plating layer

The volume of the multilayer body was calculated assuming that the dimension 1 in the first direction y was 0.220 mm, the dimension w in the second direction z was 0.110 mm, and the dimension t in the laminating direction x was 0.110 mm.

The total volume of the internal electrodes was calculated as follows. First, the outer electrode disposed on the multilayer body was peeled off, and the area A was measured by (the dimension w of the internal electrodes disposed in the multilayer body)×(the thickness t₂ of the internal electrodes in the laminating direction x). The area A was calculated as an average of cross sections of the internal electrodes exposed on the third surface 12c and the fourth surface 12d. Then, the multilayer body was ground in the second direction z so that the dimension thereof is halved to expose the cross section of the multilayer body in the first direction y and the laminating direction x. On the exposed cross section of the multilayer body, the number of laminated internal electrodes and the dimension of the internal electrodes in the first direction y were calculated. Then, the total volume of the internal electrodes was calculated by (the area A)×(the number of laminated internal electrodes)×(the dimension of the internal electrodes in the first direction y). The thickness t₁ of the dielectric layers in the laminating direction x and the thickness t₂ of the internal electrodes in the laminating direction x were calculated as averages obtained by measuring five points at equal intervals in each of three layers in a portion where no structural defect was occurring.

After each of the multilayer ceramic capacitor samples was mounted on a mount substrate, the number of occurrences of a structural defect in the multilayer ceramic capacitor was counted when a weight was dropped so as to apply a force of 10 N. 100 samples were tested for each sample type.

Table 1 shows results of the impact test conducted on the multilayer ceramic capacitor samples of Examples 1 to 4 and Comparative Examples 1 and 2 that vary in ratio of a thickness of an internal electrode in the laminating direction x to a thickness in the laminating direction x of a dielectric layer sandwiched between internal electrodes in the laminating direction. Table 1 also shows how the samples vary in electrostatic capacitance. Table 2 shows results of the impact test conducted on the multilayer ceramic capacitor samples of Examples 5 to 10 and Comparative Example 3 that vary in ratio of a total volume of internal electrodes to a volume of a multilayer body. Table 2 also shows how the samples vary in electrostatic capacitance.

TABLE 1

| | | Thickness of | | The number of | |
|---|---|---|---|---|---|
| | Thickness of | internal | Thickness of internal | occurrences of | Electrostatic |
| | dielectric | electrode | electrode/thickness | structural defect (the | capacitance |
| | layer (μm) | (μm) | of dielectric layer | number of samples) | (pF) |
| Example 1 | 4.26 | 1.69 | 0.40 | 0/100 | 5 |
| Example 2 | 4.30 | 1.77 | 0.41 | 0/100 | 10 |
| Example 3 | 3.25 | 1.48 | 0.46 | 0/100 | 5 |
| Example 4 | 4.23 | 2.01 | 0.48 | 0/100 | 10 |
| Comparative | 3.99 | 2.33 | 0.58 | 1/100 | 5 |
| Example 1 | | | | | |
| Comparative | 4.21 | 2.56 | 0.61 | 1/100 | 10 |
| Example 2 | | | | | |

TABLE 2

| | | Total volume | | The number of | |
|---|---|---|---|---|---|
| | Volume of | of internal | Total volume of internal | occurrences of | Electrostatic |
| | multilayer | electrodes | electrodes/volume of | structural defect (the | capacitance |
| | body (μm²) | (μm²) | multilayer body | number of samples) | (pF) |
| Example 5 | 2662000 | 149072 | 0.056 | 0/100 | 1 |
| Example 6 | 2662000 | 159720 | 0.060 | 0/100 | 5 |
| Example 7 | 2662000 | 175692 | 0.066 | 0/100 | 10 |
| Example 8 | 2662000 | 189002 | 0.071 | 0/100 | 10 |
| Example 9 | 2662000 | 191664 | 0.072 | 0/100 | 10 |
| Example 10 | 2662000 | 226270 | 0.085 | 0/100 | 10 |
| Comparative | 2662000 | 234256 | 0.088 | 2/100 | 10 |
| Example 3 | | | | | |

According to Table 1, in the samples of Examples 1 to 4, an occurrence of a structural defect such as delamination in the multilayer body was not observed since the ratio of the thickness of the internal electrode in the laminating direction x to the thickness in the laminating direction x of the dielectric layer sandwiched between the internal electrodes in the laminating direction was equal to or less than about 0.48, for example. On the other hand, a structural defect such as delamination in the multilayer body was found in one sample out of 100 samples according to Comparative Example 2 and one sample out of 100 samples according to Comparative Example 3 since the ratio of the thickness of the internal electrode in the laminating direction x to the thickness in the laminating direction x of the dielectric layer sandwiched between the internal electrodes in the laminating direction was 0.58 in Comparative Example 2 and 0.61 in Comparative Example 3, which are greater than about 0.48.

According to Table 2, in the samples of Examples 5 to 10, an occurrence of a structural defect such as delamination in the multilayer body was not observed since the ratio of the total volume of the internal electrodes to the volume of the multilayer body was equal to or less than about 0.085, for example. On the other hand, in Comparative Example 3, a structural defect such as delamination in the multilayer body was found in two samples out of 100 samples since the ratio of the total volume of the internal electrodes to the volume of the multilayer body was 0.088, which is greater than about 0.085.

In the samples of Example 6, the electrostatic capacitance was about 5 pF, and occurrence of a structural defect such as delamination in the multilayer body was not observed since the ratio of the total volume of the internal electrodes to the volume of the multilayer body was equal to or greater than about 0.060. In the samples of Example 6, the electrostatic capacitance was about 10 pF, and occurrence of a structural defect such as delamination in the multilayer body was not observed since the ratio of the total volume of the internal electrodes to the volume of the multilayer body was equal to or greater than about 0.066.

It was confirmed from the above results that according to example embodiments of the present invention, the impact test results became favorable in a case where the ratio of the thickness of the internal electrode in the laminating direction x to the thickness in the laminating direction x of the dielectric layer sandwiched between the internal electrodes in the laminating direction was equal to or less than about 0.48 and the ratio of the total volume of the internal electrodes to the volume of the multilayer body was equal to or less than about 0.085, for example.

Although the example embodiments of the present invention are disclosed in the above description, the present invention is not limited to this.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface that are opposed to each other in a laminating direction, a third surface and a fourth surface that are opposed to each other in a first perpendicular or substantially perpendicular to the laminating direction, and a fifth surface and a sixth surface that are opposed to each other in a second perpendicular or substantially perpendicular to the laminating direction and the first direction;
a first outer electrode on the third surface of the multilayer body; and
a second outer electrode on the fourth surface of the multilayer body; wherein
the multilayer body includes internal electrodes and dielectric layers;
the internal electrodes include Cu as a main component;
the dielectric layers include a dielectric material with a perovskite structure including Ca and Zr as a main component;
a ratio of a thickness of each of the internal electrodes in the laminating direction to a thickness in the laminating direction of each of the dielectric layers sandwiched between the internal electrodes in the laminating direction is equal to or less than about 0.48; and
a ratio of a total volume of the internal electrodes to a volume of the multilayer body is equal to or less than about 0.085.

2. The multilayer ceramic capacitor according to claim 1, wherein the ratio of the total volume of the internal electrodes to the volume of the multilayer body is equal to or greater than about 0.060.

3. The multilayer ceramic capacitor according to claim 1, wherein the ratio of the total volume of the internal electrodes to the volume of the multilayer body is equal to or greater than about 0.066.

4. The multilayer ceramic capacitor according to claim 1, wherein
a dimension of the multilayer body in the laminating direction is equal to or greater than about 0.115 mm and equal to or less than about 0.135 mm;
a dimension of the multilayer body in the first direction is equal to or greater than about 0.240 mm and equal to or less than about 0.260 mm; and
a dimension of the multilayer body in the second direction is equal to or greater than about 0.115 mm and equal to or less than about 0.135 mm.

5. The multilayer ceramic capacitor according to claim 4, wherein
a dimensional ratio of a thickness of a first outer layer portion in the laminating direction to a thickness of a second outer layer portion in the laminating direction is equal to or greater than 1:1 and equal to or less than 1:3; and
the first outer layer portion is a region located between an internal electrode closest to the first surface among the internal electrodes and the first surface, and the second outer layer portion is a region located between an internal electrode closest to the second surface among the internal electrodes and the second surface.

6. The multilayer ceramic capacitor according to claim 5, wherein
the thickness of the first outer layer portion is equal to or greater than about 5 μm and equal to or less than about 15 μm; and
the thickness of the second outer layer portion is equal to or greater than about 5 μm and equal to or less than about 15 μm.

7. The multilayer ceramic capacitor according to claim 1, wherein the multilayer body has a rectangular or substantially rectangular parallelepiped shape.

8. The multilayer ceramic capacitor according to claim 1, wherein the first surface and the second surface of the multilayer body are flat.

9. The multilayer ceramic capacitor according to claim 1, wherein the first surface, the second surface, the third surface, the fourth surface, the fifth surface, and the sixth surface of the multilayer body are roughened.

10. The multilayer ceramic capacitor according to claim 1, wherein the multilayer body includes rounded corner portions and rounded ridge portions.

11. The multilayer ceramic capacitor according to claim 1, wherein a thickness of each of the internal electrodes in the laminating direction is equal to or greater than about 0.5 μm and equal to or less than about 3.5 μm.

12. The multilayer ceramic capacitor according to claim 1, wherein a total number of the internal electrodes included in the multilayer body is 6 or more.

13. The multilayer ceramic capacitor according to claim 1, wherein the multilayer body includes a first outer layer portion including a plurality of first outer dielectric layers and a second outer layer portion including a plurality of second outer dielectric portions.

14. The multilayer ceramic capacitor according to claim 13, wherein an inner layer portion is located between the first outer layer portion and the second outer layer portion.

15. The multilayer ceramic capacitor according to claim 14, wherein thicknesses of the first outer layer portion and the second outer layer portion are equal to or greater than about 5 μm and equal to or less than about 15 μm.

16. The multilayer ceramic capacitor according to claim 1, wherein each of the first outer electrode and the second outer electrode includes a base electrode layer including a metal and glass, and a plating layer on the base electrode layer.

17. The multilayer ceramic capacitor according to claim 16, wherein the base electrode layer includes a first base electrode layer and a second base electrode layer.

18. The multilayer ceramic capacitor according to claim 16, wherein the base electrode layer include copper and glass.

19. The multilayer ceramic capacitor according to claim 17, wherein a thickness of each of the first base electrode layer and the second base electrode layer is equal to or greater than approximately 10 μm and equal to or less than approximately 40 μm.

20. The multilayer ceramic capacitor according to claim 16, wherein the plating layer includes a first plating layer and a second plating layer.
